(19) United States
(12) Patent Application Publication
(10) Pub. No.: US 2024/0428195 A1
(43) Pub. Date: Dec. 26, 2024

(54) SYSTEMS AND METHODS TO GENERATE UNITS OF WORK WITHIN A COLLABORATION ENVIRONMENT BASED ON AUDIO

(71) Applicant: Asana, Inc., San Francisco, CA (US)

(72) Inventor: Alexander Hood, San Francisco, CA (US)

(21) Appl. No.: 17/036,573

(22) Filed: Sep. 29, 2020

(51) Int. Cl. G06Q 10/10; G06Q 10/06; G10L 15/26

(52) U.S. Cl. CPC G06Q 10/103; G06Q 10/06316; G10L 15/26; G10L 2015/088; G10L 2015/228

(57) ABSTRACT

Systems and methods to generate units of work within a collaboration environment based on audio are described herein. Exemplary implementations may: manage environment state information maintaining a collaboration environment; obtain audio information characterizing audio content of the audio recording sessions; generate one or more units of work for the users based on the audio content of the audio recording sessions by storing information defining the one or more units of work as part of the environment state information; store the audio information as part of the environment state information; and/or perform other operations.

### FIELD OF THE DISCLOSURE

The present disclosure relates to generating units of work within a collaboration environment based on audio.

### BACKGROUND

Collaboration environments, sometimes referred to as integrated collaboration environments, may enable users to assign projects, tasks, or other assignments to assignees (e.g., other users) to complete. A collaboration environment may comprise an environment in which a virtual team of users does its work. A collaboration environment may enable users to work in a more organized and efficient manner. A collaboration environment may integrate features and/or functionality such as web-based conferencing and collaboration, desktop videoconferencing, and/or instant message into a single easy-to-use, intuitive interface.

### SUMMARY

One aspect of the present disclosure relates to a system configured to generate units of work within a collaboration environment based on audio. Collaboration environments typically require users to manually input to-do items. Audio recording sessions may solve one or more problems with conventional solutions where manual input of the units of work may be otherwise required. Typically, without such manual input, computers generally cannot generate and/or manage units of work for users automatically. This creates more work for users and reduces user efficiency. As such, users and companies waste valuable resources and may be unlikely to use a work management platform long term. One or more implementations of the systems and methods presented herein may facilitate generating one or more units of work in based an audio recording session. In some implementations, determining the one or more units of work may be based on tone of speech of the one or more users participating in the audio recording session and/or other information.

One aspect of a system configured to generate units of work within a collaboration environment based on audio may include one or more of: one or more servers, one or more client computing platforms, and/or other components. The one or more servers may be configured to communicate with one or more client computing platforms according to a client/server architecture and/or other architecture. The one or more servers and/or client computing platforms may include one or more physical processors configured to execute one or more computer program components. The computer program components may include one or more of an environment state component, a collaboration environment component, a recording component, a work component, a trigger phrase component, and/or other components.

The environment state component may be configured to manage environment state information maintaining a collaboration environment. The collaboration environment may be configured to facilitate interaction by users with the collaboration environment and/or other interactions. The environment state information may include work units records describing units of work assigned, created, and/or managed within the collaboration environment. The environment state component may be configured to effectuate transmission of the environment state information to client computing platform(s), and/or vice versa. In some implementations, the environment state component may be configured to receive information over a network from the client computing platforms(s). The environment state component may be configured to effectuate storage of the received information as environment state information to one or more of user records, project records, work unit records, and/or other records.

The recording component may be configured to obtain user input information and/or other information. The user input information may characterize user-initiation of audio recording sessions by individual users of the collaboration environment.

The recording component may be configured to obtain audio information and/or other information. The audio information may characterize audio content of the audio recording sessions. The audio content may include speech of the individual users during the audio recording sessions and/or other audio content. By way of non-limiting illustration, the recording component may obtain first audio information characterizing audio content of the first audio recording session.

The work component may be configured to generate one or more units of work based on the audio content of the audio recording sessions and/or other information. The work component may be configured to generate one or more units of work by storing information defining the one or more units of work as part of the environment state information. As such, one or more work unit records of the one or more units of work may be generated. By way of non-limiting illustration, a first unit of work may be generated based on the audio content of the first audio recording session by storing information defining the first unit of work in a first work unit record.

The work component may be configured to store the audio information as part of the environment state information and/or other information. The audio information may be included in the one or more work unit records generated for the one or more units of work. By way of non-limiting illustration, the first audio information may be stored in the first work unit record.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to generate units of work within a collaboration environment based on audio, in accordance with one or more implementations.

FIG. 2 illustrates a method to generate units of work within a collaboration environment based on audio, in accordance with one or more implementations.

FIG. 3A illustrates an implementation of the system of FIG. 1.

FIG. 3B illustrates a user interface, in accordance with one or more implementations.

FIG. 4 illustrates a user interface, in accordance with one or more implementations.

### DETAILED DESCRIPTION

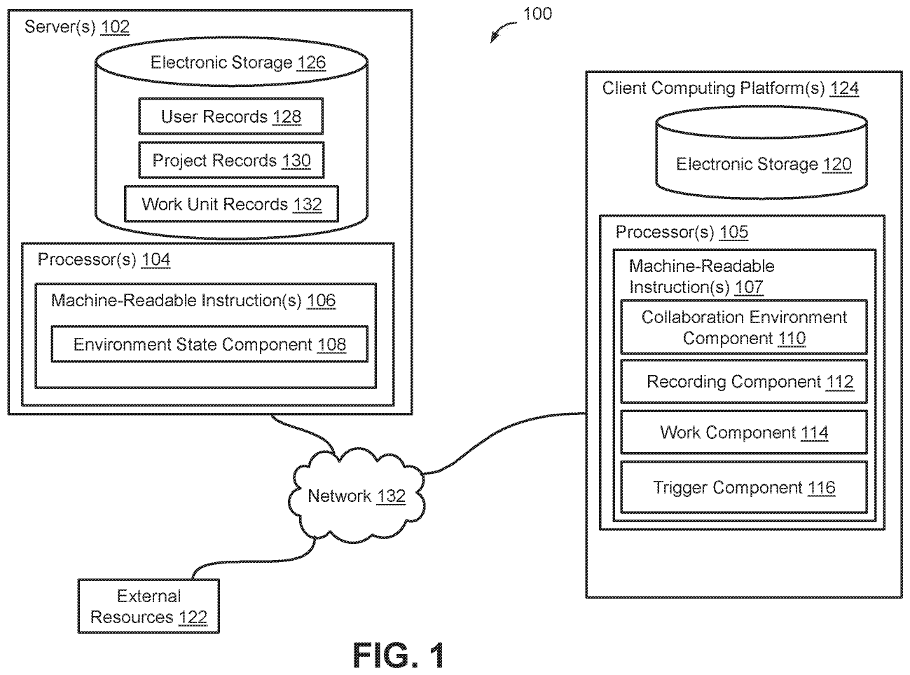

FIG. 1 illustrates a system 100 configured to generate units of work within a collaboration environment based on audio. Audio recording and/or dictation may solve one or more problems with conventional solutions where manual input of the units of work may be otherwise required. The units of work may be determined dynamically for one or more users participating in an audio recording session through a user interface, based on content from the audio recording session through the user interface, and/or external audio sources. Units of work may be generated in real-time, near-real time, and/or at an end of a given audio recording session. In some implementations, the audio recording session may be recorded and one or more units of work may be generated after-the-fact.

The presentation of the collaboration environment may be based on environment state information and/or other information. The environment state information may include user records 128, project records 130, work unit records 132, and/or other records. The environment state information may be continuously generated and/or updated based on the state of the collaboration environment representing the users' interactions with the collaboration environment. The state of the collaboration environment may include a user state, a project state, a work unit state, and/or other states. The user state may be defined by user records 128. User records 128 may define user information associated with users interacting with and/or viewing the collaboration environment. The project state may be defined by project records 130. Project records 130 may define project information for projects managed within the collaboration environment. Managing may include one or more of obtaining, defining, storing, updating, deleting, and/or other operations. The work unit state may be defined by work unit records 132. Work unit records 132 may define work information for units of work assigned to, created by, and/or managed by individual users within the collaboration environment.

The user information may include values of user parameters and/or other information. The values of the user parameters may be organized in user records corresponding to users interacting with and/or viewing the collaboration environment. The values of the user parameters associated with the users interacting with and/or viewing the collaboration environment may include information describing the users, their actions within the collaboration environment, their settings, and/or other user information; and/or metadata associated with the users, their actions within the environment, their settings, and/or other user information. Individual ones of the users may be associated with individual ones of the user records. A user record may define values of the user parameters associated with a given user interacting with and/or viewing the collaboration environment.

The values of the user parameters may, by way of non-limiting example, specify one or more of: a user name, a group parameter, a user account, user role information, a user department, descriptive user content, a to-email, a from-email, a photo, an organization, a workspace, one or more projects (which may include project parameters defined by one or more work unit records), one or more items of work (which may include one or more unit of work parameters defined by one or more unit of work records), one or more user comments, one or more teams the user belongs to, one or more of the user display settings (e.g., colors, size, project order, task order, other unit of work order, etc.), one or more authorized applications, one or more interaction parameters (e.g., indicating a user is working on/worked on a given unit of work, a given user viewed a given unit of work, a given user selected a given unit of work, a timeframe a given user last interacted with and/or worked on a given unit of work, a time period that a given unit of work has been idle, and/or other interaction parameters), a presence parameter (e.g., indicating presence and/or interaction level at an environment level, unit of work level, project level, task level, application level, etc.), one or more notification settings, one or more progress parameters, status information for one or more units of work the user is associated with (units of work assigned to the user, assigned to other users by the user, completed by the user, past-due date, and/or other information), one or more performance metrics of a given user (e.g., how many units of work the user has completed, how quickly the user completed the units of work, how quickly the user completes certain types of units of work, the efficiency of the user, bandwidth of the user, activity level of the user, etc.), application access information (e.g., username/password for one or more third-party applications), one or more favorites and/or priorities, schedule information, sets of preferences of a given user, other user parameters for the given user.

User role information may specify individual roles of the individual users in the individual units of work. A role may represent a position of an individual user. The position may be specified based on a description of one or more of job title, level, stage, and/or other descriptions of position. The role may be specified with respect to a company as a whole, a particular unit of work, and/or other considerations. By way of non-limiting illustration, a role may include one or more of chief executive officer (or other officer), owner, manager, supervisor, accountant, associate, employee, entry level, intern, midlevel, senior, administrator, director, foreman, engineer, product developer, human resource officer, artist, art director, and/or other description.

Schedule information for the individual users may include one or more calendar entries associated with the individual users. The individual calendar entries may be associated with individual start dates and individual end dates.

In some implementations, schedule information may be stored locally within electronic storage 126 by virtue of features and/or functionality provided within a collaboration environment. By way of non-limiting illustration, a collaboration environment may have the features and/or functionality of a calendar application configured to facilitate calendaring entries into a schedule. It is noted that schedule information may be determined through features and/or functionality provided by one or more external resources 122. By way of non-limiting illustration, an external resource may include a calendar application which may be external to a collaboration environment. The collaboration environment may have permissions to access the external calendar application to determine and/or obtain schedule information.

The work information may include values of one or more work unit parameters. The values of the work unit parameters may be organized in work unit records corresponding to units of work managed, created, and/or assigned within the collaboration environment. A given unit of work may have one or more assignees and/or team members working on the given unit of work. Units of work may be associated with one or more to-do items, action items, objectives, and/or other units of work one or more users should accomplish and/or plan on accomplishing. Units of work may be created by a given user for the given user and/or created by the given user and assigned to one or more other users. A given unit of work may include one or more of a task, a sub-task, and/or other units of work possibly assigned to and/or associated with one or more users.

The individual sets of preferences of the individual users may include individual sets of automated actions to carry out in response to occurrence of individual trigger events. The automated actions may include one or more of generation of a project, generation of a unit of work, assignment to a particular user, attachment of one or more particular documents, setting one or more values of one or more work unit parameters, and/or other actions that may be automated responsive to trigger events.

In some implementations, individual sets of automated actions and associated individual trigger events may be stored in individual automation records. An automation record may define one or more of individual actions, individual trigger events, and/or other information. Individual actions may be defined by a target component, an action component, and/or other information. The target component of an automation record may include the environment parameter (or parameters) to which an action is to be carried out on. The action component of an automation record may define what change is to be made on the environment parameter (or parameters) defined by the target component.

Individual trigger events may be defined by a source component, an event component, and/or other information. The source component of an automation record may include the environment parameter (or parameters) from which occurrences of a trigger event may be derived. The event component may include the value (or change in the value) for the environment parameter (or parameters) defined by the source component from which occurrences of a trigger event may be derived.

In some implementations, individual automation records may store counts of occurrences of individual trigger events and/or occurrences of carrying out individual automation actions in the sets of automation actions.

It is noted that while some descriptions presented herein may be directed to an individual trigger event causing an individual set of automated actions to be carried out within the collaboration environment, this is for illustrative purposes only and not to be considered limiting. For example, in some implementations, multiple trigger events may be combined together through some logic criteria, that when satisfied, may cause an individual set of automated actions to be carried out within the collaboration environment. Logic may include, for example, Boolean logic. By way of non-limiting illustration, logic operators such as “AND”, “OR”, “NOT”, and/or other operations may be utilized to generate more complex trigger combinations for sets of automated actions. In some implementations, the use of logic operators may allow for fewer discrete trigger events to be defined yet still have more complex behavior available to users. For example, there may not be a need to specify a trigger event of “when task is unassigned”, since through the use of a logic operator “NOT”, a trigger event may be defined by “when task assigned” combined with the operator “NOT”. Further, the Boolean logic may facilitate multistage automation. By way of non-limiting illustration, instead of input “than-if-then” or “if-and-if-then”, logic may include “if-then-then” and/or other operators. In some implementations, a user may specify a set, or pool, of trigger events to trigger one or more automated actions. In some implementations, a user may specify that one or more of the trigger events in the set may individually and/or in combination trigger the one or more automated actions. This way, a user may specify multiple options of trigger events which may trigger one or more automated actions. Further, an individual trigger event may trigger multiple automated actions.

Individual work unit records may include hierarchical information defining a record hierarchy of the individual work unit records. The hierarchical information of a work unit record may include one or more of information identifying other work unit records associated in a record hierarchy the work unit record belongs to, a specification of the position of the work unit record in the hierarchy, restrictions and/or other relationships placed on the work unit record by virtue of its position, and/or other information.

A record hierarchy may convey individual positions of individual work unit records (and their corresponding units of work) in the record hierarchy. By way of non-limiting illustration, a position may specify one or more of a work unit record being superior to another work unit record, a work unit record being subordinate to another work unit record, and/or other information. As a result, individual work unit records in the individual sets of work unit records may be subordinate to other individual work unit records in the individual sets of work unit records. For example, a work unit record may define a unit of work comprising a task, and a subordinate work unit record may define a unit of work comprising a sub-task to the task. A record hierarchy may define a relationship between work unit records. A work unit record may have some restrictions placed on it by virtue of having a subordinate work unit record. By way of non-limiting illustration, a work unit record may be restricted from access by one or more users unless and/or until a subordinate work unit record is completed and/or started.

The one or more work unit parameters may include one or more of a work assignment parameter, a work management parameter, work creation parameter, and/or other parameters. The values of the work assignment parameter may describe units of work assigned to the individual users. The values of the work management parameter may describe units of work managed by the individual users. The values of the work creation parameter may describe units of work created by the individual users.

In some implementations, values of one or more work unit parameters of a given unit of work may describe the unit of work based on one or more of a unit of work name, a unit of work description, one or more unit of work dates (e.g., a start date, a due date, an end date, a completion date, and/or dates), one or more members associated with a unit of work (e.g., an owner, one or more other project/task members, member access information, and/or other unit of work members and/or member information), a status parameter (e.g., an update, a hardcoded status update, a completed/uncomplete/mark complete, a measured status, a progress indication, quantity of sub-work units remaining for a given unit of work, completed units of work in a given project, and/or other status parameter), one or more user comment parameters (e.g., permission for who may comments such as a creator, a recipient, one or more followers, and/or one or more other interested parties; content of the comments; one or more times; presence or absence of the functionality of up-votes; one or more hard-coded responses; and/or other parameters.), one or more interaction parameters (e.g., indicating a given unit of work is being worked on/was worked on, given unit of work was viewed, a given unit of work was selected, how long the given unit of work has been idle, a last interaction parameter indicating when and what user last interacted with the given unit of work, users that interacted with the given unit of work, and/or other interaction parameters indicating sources of the interactions, context of the interactions, content of the interactions and/or time for the interactions), one or more file attachments, notification settings, privacy, an associated URL, one or more interaction parameters (e.g., sources of the interactions, context of the interactions, content of the interactions, time for the interactions, and/or other interaction parameters), updates, ordering of units of work within a given unit of work (e.g., tasks within a project, subtasks within a task, etc.,), state of a workspace for a given unit of work (e.g., application state parameters, application status, application interactions, user information, and/or other parameters related to the state of the workspace for a unit of work), dependencies between one or more units of work, one or more custom fields (e.g., priority, cost, stage, and/or other custom fields), a work priority parameter, and/or other information. Values to the work priority parameter may indicate priority of a given unit of work over other units of work.

The values of the work assignment parameter describing units of work assigned to the individual users may be determined based on one or more interactions by one or more users with a collaboration environment. In some implementations, one or more users may create and/or assign one or more unit of work to themselves and/or an other user. In some implementations, a user may be assigned a unit of work and the user may effectuate a reassignment of the unit of work from the user or one or more other users.

In some implementations, values of the work assignment parameter may indicate that a status parameter of a unit of work has changed from “incomplete” to “marked complete” and/or “complete”. In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date). In some implementations, for the purposes of measuring workload, values of the work assignment parameter for a unit of work indicating a status of “marked complete” and/or “complete” may be treated as if the unit of work is no longer assigned to the user for the purpose of measuring a current workload of the user.

The project information may define values of project parameters for projects managed within the collaboration environment. The project parameters may characterize one or more projects managed within the collaboration environment and/or via the collaboration work management platform, and/or the metadata associated with the one or more projects. Individual ones of the projects may be associated with individual ones of the project records. The project information may define values of the project parameters associated with a given project managed within the collaboration environment and/or via the collaboration work management platform. A given project may have one or more owners and/or one or more team members working on the given project. A given project may include one or more units of work assigned to one or more users under a given project heading. A given project may include a plurality of units of work assigned to one or more users under a given project heading.

The project parameters may, by way of non-limiting example, include one or more of: individual units of work within individual ones of the projects (which may include parameters defined by one or more work unit records), one or more user comment parameters (e.g., a creator, a recipient, one or more followers, one or more other interested parties, content, one or more times, upvotes, other hard-coded responses, etc.), a project name, a project description, one or more project dates (e.g., a start date, a due date, a completion date, and/or other project dates), one or more project members (e.g., an owner, one or more other project members, member access information, and/or other project members and/or member information), a status and/or progress (e.g., an update, a hardcoded status update, a measured status, quantity of units of work remaining in a given project, completed units of work in a given project, and/or other status parameter), one or more attachments, notification settings, privacy, an associated URL, one or more interaction parameters (e.g., sources of the interactions, context of the interactions, content of the interactions, time for the interactions, and/or other interaction parameters), updates, ordering of units of work within the given project, state of a workspace for a given task within the given project, other project parameters for the given project, and/or other information

As is illustrated in FIG. 1, system 100 may include one or more of one or more servers 102, one or more client computing platforms 124, external resources 122, and/or other components. Users may interact with system 100 via one or more client computing platforms 124. The one or more servers 102 may be configured to communicate with one or more client computing platforms 124 according to a client/server architecture and/or other communication schemes. The one or more client computing platforms 124 may include one or more of a cellular telephone, a smartphone, a digital camera, a laptop, a tablet computer, a desktop computer, a television set-top box, smart TV, a gaming console, and/or other client computing platforms.

The one or more servers 102 may include one or more physical processors 104 (also referred to herein as “one or more processors” and/or “processor(s)”), non-transitory electronic storage 126, and/or other components. Non-transitory electronic storage 126 may include one or more records. The one or more records may store the environment state information that defines the state of the collaboration environment. The state of the collaboration environment may include a user state, a project state, a work unit state, and/or other states. The records may include the user records 128, the project records 130, the work unit records 132, and/or other records. The one or more physical processors 104 may be configured to access one or more of user records 128, project records 130, work unit records 132, and/or other records to effectuate transmission of the environment state information over network 132 to client computing platform(s) 124. Client computing platform(s) 124 may use the environment state information to effectuate presentation of the collaboration environment via client computing platform(s) 124.

The one or more physical processors 104 may be configured to execute machine-readable instructions 106. The machine-readable instructions 106 may include one or more computer program components. The computer program components may include an environment state component 108 and/or other components.

The client computing platform(s) 124 may include one or more physical processors 105, non-transitory electronic storage 120, and/or other components. The one or more physical processors 105 may be configured to execute machine-readable instructions 107. The machine-readable instructions 107 may include one or more computer program components. The computer program components may include one or more of a collaboration environment component 110, a recording component 112, a work component 114, a trigger component 116, and/or other components.

It is noted that while some computer program components may be shown and/or described as attributed to an individual one of one or more of client computing platform(s) 124 and/or server(s) 102, this is for illustrative purposes only. Instead, it is to be understand that the features and/or functionality of one or more of the computer program components attributed to client computing platform(s) 124 may additionally and/or alternatively be attributed to server(s) 102, and vice versa.

In some implementations, server(s) 102 may be configured to provide remote hosting of the features and/or functions of machine-readable instructions 106 to one or more client computing platform(s) 124 that may be remotely located from server(s) 102. In some implementations, one or more features and/or functions of server(s) 102 may be attributed as local features and/or functions of one or more client computing platform(s) 124. For example, individual ones of the client computing platform(s) 124 may include one or more additional machine-readable instructions comprising the same or similar components as machine-readable instructions 106 of server(s) 102. The client computing platform(s) 124 may be configured to locally execute the one or more components that may be the same or similar to the machine-readable instructions 106. One or more features and/or functions of machine-readable instructions 106 of server(s) 102 may be provided, at least in part, as an application program that may be executed at a given client computing platform 124. One or more features and/or functions of machine-readable instructions 107 may be provided, at least in part, at server(s) 102.

The client computing platform(s) 124 may monitor, and/or collect information for transmission to the one or more server(s) 102 to be stored as environment state information. The client computing platform(s) 124 may obtain and/or collect environment state information from the one or more server(s) 102.

Referring now to server(s) 102, the environment state component 108 may be configured to manage environment state information and/or other information used in maintaining a collaboration environment. Managing may include one or more of obtaining, defining, storing, updating, deleting, and/or other operations. The collaboration environment may be configured to facilitate interaction by users with the collaboration environment and/or other interactions. The environment state information may include one or more of the user information, work information, and/or other information used to define, support, and/or otherwise maintain a collaboration environment.

The environment state component 108 of machine-readable instructions 106 may be configured to effectuate transmission of the environment state information to client computing platform(s) 124, and/or vice versa. In some implementations, environment state component 108 may be configured to receive information over network 132 from client computing platforms(s) 124. Environment state component 108 may be configured to effectuate storage of the received information as environment state information to one or more user records 128, project records 130, work unit records 132, and/or other records. Environment state component 108 may be configured to obtain one or more user records 128, project records 130, work unit records 132, and/or other records in response to and/or based on one or more requests from client computing platform(s) 124. Environment state component 108 may be configured to effectuate transmission of values for user parameters, values for project parameters, values for work unit parameters, and/or other state information to client computing platform(s) 124. The values for user parameters, values for project parameters, values for work unit parameters, and/or other state information may be used to effectuate presentation of the relevant units of work and/or projects for a given user of the collaboration environment associated with the given client computing platform to which the values and/or other state information is transmitted.

Collaboration environment component 110 of machine-readable instructions 107 of client computing platform(s) 124 may be configured to effectuate presentation of one or more user interfaces of a collaboration environment. Presentation of the collaboration environment may be based on environment state information and/or other information.

Collaboration environment component 110 may be configured to effectuate presentation of a user interface through which the users initiate individual audio recording sessions. The user interface may include one or more user interface elements. An individual user interface element may be configured to be selected by the users to cause the user-initiation of the audio recording sessions. The user interface elements may be configured to facilitate user interaction with the user interface, user entry, and/or selection. By way of non-limiting illustration, the user interface elements may include one or more of text input fields, drop down menus, check boxes, display windows, virtual buttons, and/or other user interface elements. In some implementations, the user interface may be presented within and/or outside the collaboration environment. In some implementations, a user interface through which the users initiate individual audio recording sessions may be provided an external resource (e.g., an application outside of the system 100 and/or other resources).

The client computing platform(s) 124 may effectuate presentation of one or more user interfaces of the collaboration environment. The collaboration environment may include the environment in which users interact with and/or view the one or more units of work and/or projects managed via the collaboration work management platform. The collaboration environment may exist whether or not a given user is viewing and/or interacting with the collaboration environment. In some implementations, projects managed via the collaboration environment may include one or more units of work. By way of non-limiting example, the one or more units of work may include action items, to-do items, and/or objectives within a given project. The one or more units of work may be assigned to one or more users such that the one or more units of work assigned to a given user may appear on a given user's task list within the collaboration environment.

Recording component 112 may be configured to obtain audio information and/or other information. The audio information may characterize audio content of the audio recording sessions. The audio content may include speech (e.g., words, phrases, noises, etc.) of the individual users during the audio recording sessions and/or other audio content. In some implementation, the audio content of the audio recording sessions may be derived from the audio information based on one or more audio processing techniques through which individual ones of the audio content, and/or other content may be determined.

In some implementations, audio information may be obtained in real-time during the audio recording session, in near real-time, at the end of a given audio recording session, and/or at any other time during and/or after the given audio recording session. For example, the audio recording sessions may be live. As such, the audio information may be obtained in real time as the users utter the speech. As another example, the audio recording sessions may be prerecorded such that the audio information is obtained from non-transitory electronic storage (e.g., electronic storage 120 and/or 126). By way of non-limiting example, the audio recording session may include one or more of a patient visit, a meeting recording, a virtual meeting recording, a phone call, a video call, a voice memo, and/or other audio recording sessions which may be live or prerecorded and stored in the non-transitory electronic storage.

In some implementations, recording component 112 may be configured to obtain user input information and/or other information. The user input information may characterize the user-initiation of the audio recording sessions by individual users of the collaboration environment. Thus, responsive to the user-initiation of the audio recording sessions, recording component 112 may obtain the audio information and/or other information. The user-initiation of the audio recording sessions by individual users may be a selection of one or more of the user interface elements, user entry by way of the one or more of the user interface elements, and/or user entry via one or more input devices (e.g., keyboard, mouse, etc.). The user interface elements may be presented to the individual users within a given project, within a given unit of work, and/or otherwise within and/or outside the collaboration environment. In some implementations, selection and/or interaction with the one or more user interface elements to initiate an audio recording session may automatically associate the audio recording session with a given project, a given unit of work, and/or provide other automatic association. As a result, generation of one or more values of one or more work unit parameters (e.g., assignees, due dates, start dates, etc.) of a given unit of work (e.g., task) may be generated and/or otherwise facilitate streamline generation and/or modification of units of work based on the audio recording session because this information may already be known by virtue of the automatic association. By way of non-limiting illustration, one or more units of work may be selected prior to an initiation of an audio recording session such that the one or more units of work may be queued up for modification and/or other interactions based on the audio content of the audio recording session.

In some implementations, the client computing platform 124 may include an audio section configured to receive input (e.g., the audio recording session) from the user. The audio section may include one or more of an audio sensor, an audio encoder, a speaker, and/or other components. The audio sensor (e.g., a microphone) may be configured to generate output signals conveying the audio information and/or other information.

The audio sensor may be configured to detect the sounds represented by the audio information. The audio sensor may include a single audio sensor or an array of audio sensors. The one or more audio sensors may be discreet microphones, prominent microphones, array microphones, and/or other microphones. The audio sensor(s) may be configured to convert the sounds represented by the audio information to digital signals. Converting the sounds represented by the audio information may include converting analog waves to digital signals by precisely measuring the analog waves at consistent and frequent intervals. The digital signals may include noise that is unwanted. The sound sensor(s) may be configured to filter the digital signals of the noise.

In some implementations, the audio encoder may encode the digital signals to an audio file according to an audio file format such that the digital signals are compressed. By way of non-limiting example, the audio file format may include apple lossless audio, True Audio (TTA), Free Lossless Audio Code (FLAC), Moving Picture Experts Group Layer-3 (MP3), Advanced Audio Coding (AAC), Waveform Audio File Format (WAV), and/or other audio file formats. The audio encoder may encode the digital signals to the audio file always, never, for each audio recording session of use, when the audio information is determined to have more noise than signal in a signal-to-noise ratio (SNR), when configured to store the audio file, and/or on other terms. SNR may be defined as the ratio between signal and noise in which an audio file has more signal than noise with a high SNR.

The audio file may be stored on electronics storage 120, electronic storage 126, and/or other storage media. The audio file may be stored in one of the audio file formats. Each audio file of audio information may be stored always, never, for each audio recording session of use, when the audio information is determined to have more noise than signal in a signal-to-noise ratio (SNR), and/or on other terms. Upon storage, the audio file may be stored for a specified period of time. The specified period of time may include a day, a week, a month, a year, until manually deleted, until storage is full, and/or other specified periods of time.

By way of non-limiting illustration, the audio recording sessions may include a first audio recording session. In some implementations, the first audio recording session may be responsive to a user-initiation by a first user. First audio information characterizing audio content of the first audio recording session may be obtained. In some implementations, the audio recording sessions may be related to and/or specific to a given project and/or unit of work within the collaboration environment. As such, a user participating in a given audio recording session may be working on and/or discussing a related and/or specific project and/or unit of work. The first audio recording session may be a unit of work-specific audio recording session. For example, the first audio recording session may specific to Task A and/or one or more other units of work.

In some implementations, recording component 112 may be configured to transcribe the audio content (e.g., one or more spoken communications) that make up the audio recording session. In some implementations, the audio content may be transcribed in real-time of the audio recording session, in near real-time, at the end of a given audio recording session, and/or at any other time during and/or after the given audio recording session. In some implementations, the audio recording session may include the audio content of the user or multiple users. In some implementations, recording component 112 may be configured to determine a source of particular audio content (i.e., which user is speaking) within the audio recording session based on voice recognition and/or authentication techniques. Such determination of the source of the particular audio content may be utilized during transcription of the audio recording session to indicate which user spoke which portion(s) of the transcription and thus the audio recording session. The transcription may be stored to electronic storage 126 and/or 120 subsequent to the transcribing and for later review. In some implementations, the transcription may be associated with one or more units of work (e.g., discussed in the transcription and thus the audio recording session). It is noted that while some descriptions presented herein may be directed to generating one or more units of work for the users based on the audio content of the audio recording sessions, these same features and/or functionality may be carried out, mutatis mutandis, using a written transcription of audio content. Accordingly, identifications and/or determinations may be based on analyzing written content as opposed to audio conveying user utterances.

In some implementations, recording component 112 may be configured to determine one or more intended recipients of individual items within the audio recording session. In some implementations, determining the one or more intended recipients may be by analyzing the transcription of the audio recording session. In some implementations, determining the one or more intended recipients may be performed in real-time or near real-time during the audio recording session and/or after the fact.

In some implementations, recording component 112 may be configured to implement an instance of an audio recording session through one or more user interfaces. Recording component 112 may receive an/or transmit communications (e.g., textual communications, voice communications, video communications, etc.) that make up the audio recording session to and/or from client computing platform(s) 124 and server(s) 102. The user interface may be part of and/or external to the collaboration environment. The audio recording sessions may be hosted by the collaboration platform and/or one or more third party chat applications integrated with the collaboration platform via an application program interface (API). The audio recording sessions may be provided by one or more third-party audio applications and/or video applications via one or more APIs. The audio recording sessions may be provided by one or more third-party audio applications and/or video applications and received/imported by recording component 112. For example, the third-party audio applications and/or video applications may include a cloud-based phone system, a cloud-based video call system, a conference recording system, and/or other third-party applications. In some implementations the collaboration platform may host and/or provide one or more of the audio recording sessions.

Work component 114 may be configured to generate one or more units of work for the users based on the audio content of the audio recording sessions by storing information defining the one or more units of work as part of the environment state information. In some implementations, such generation may be responsive to detection of completion of the audio recording sessions. In some implementations, such generation may be in real-time during the audio recording session and/or in near real-time during the audio recording session. By way of non-limiting illustration, one or more work unit records of the one or more units of work may be generated. A first unit of work may be generated based on the audio content of the first audio recording session by storing information defining the first unit of work in a first work unit record.

In some implementations, generating the one or more units of work may include automatically generating one or more values of one or more work unit parameters of the one or more units of work. Generating the units of work based on the content from the audio recording sessions may include automatically initiating the one or more units of work, and/or automatically generating one or more values of one or more work unit parameters describing the units of work. In some implementations, the one or more values of the one or more work unit parameters may include one or more of a title, a description, a due-date, an assignee, a start date, a project and/or unit of work associated with the generated unit of work, a dependency within a hierarchy, a priority, indication of complete and/or incomplete, custom fields, and/or other values. In some implementations, generating the one or more units of work may include automatically generating other metadata associated with the one or more units of work.

In some implementations, the units of work may be generated in real-time and/or near real-time during the audio recording session. By way of non-limiting example, as the user starts speaking within the user interface, work component 114 may identify one or more units of work that should be generated. The units of work, in some implementations, may be generated at or near the conclusion of the audio recording sessions. In some implementations, one or more units of work generated based on the audio content from the audio recording sessions may be presented to one or more of the users as one or more recommended units of work. The recommended units of work may be presented to the one or more users, via the user interface, for confirmation and/or acceptance. One or more of the users may accept and/or confirm one or more of the recommended units of work at the conclusion of the given audio recording session to generate the units of work and/or in real time as they are presented. For example, the recommended units of work may be accepted and/or confirmed by way of the user interface elements that indicate such. The audio recording session may conclude when: a threshold amount of time passes without any communication from one or more users, a user exits or closes the user interface, the user minimizes the user interface, the user responds to a request with acceptance language and/or the user otherwise concludes the audio recording session.

In some implementations, work component 114 may identify one or more units of work associated with the audio recording session prior to and/or during the audio recording session. The identification may be based on user input from a user and/or through identification via audio analysis. Thus, work component 114 may modify the one or more units of work identified based on the audio content from the audio recording sessions. For example, the user may identify that Task A is associated with a particular audio recording session prior to commencement. Thus, when the user mentions that the due date for Task A may need to be extended, work component 112 may modify Task A directly with a new due date.

In some implementations, recording component 112 may be configured to generate speaker intention information from the audio information. The speaker intention information may convey non-verbalized intent of the users. The non-verbalized intent may include one or more of feelings, impressions, emotions other than specific words, attitudes, or other intent. For example, non-verbalized intent may include a user's request, desire, inquiry, need, concern, frustration, confusion, and/or other non-verbalized intent related to a unit of work. The non-verbalized intent may be determined from the tone of the speech and/or other information. The tone may include one or more of pitch, vibration, volume, voice inflection of the speech, intonation, or other information related to the tone.

In some implementations, recording component 112 may be configured to detect the tone and/or other information related to the tone of the speech. Such detection may facilitate determination of the non-verbalized intent and/or other information. Such determination may facilitate generation of one or more units of work, and/or other information based on the audio content of the audio information. For example, based on the intonation of the user, the user may be determined as concerned about a nearing deadline of a project. Thus, a suggestion to create a follow-up task on progress of the project may be generated.

In some implementations, the speaker intention information that triggers generation of the one or more units of work for the users may include one or more trigger sounds within the audio content of the audio recording sessions. The trigger sounds may indicate the non-verbalized intent. The trigger sounds may be based on the tone of the speech, speed of the speech, inclusion of filler words (e.g., “um”, “uh”), and/or other information related to the speech.

By way of non-limiting illustration, a trigger sound to generate an urgent unit of work may include a relatively fast speed of speech of the user and/or other sounds conveying a desire to do something they are talking about urgently. By way of non-limiting illustration, a trigger sounds to generate a unit of work with low priority may include pauses in between words, slow speed of the speech, and/or other sounds conveying a desire to do something but having little importance. The one or more units of work may be generated for the individual users based on identifying one or more of the trigger sounds from the audio content. Trigger sounds may be detected and/or identified from audio content based on one or more natural language processing techniques. By way of non-limiting illustration, the first unit of work may be generated based on identifying a first sound from the audio content of the first audio recording session.

In some implementations, recording component 112 may be configured to interpret the speech of the users based on the speaker intention information to determine a meaning of a message conveyed by the speech. Determining the meaning of the message may include determining: a difference between a question, a statement, and a command; a difference between types of questions; focus on particular elements of the speech; and/or other meanings.

Spoken words may only be a small subset of human communications. Much of what is communicated between humans may be non-verbal and/or non-speech, such as tone of voice. These communicative behaviors, when communicated alone or in combination with other communicative behaviors, may cause a meaning of a message conveyed by a user to go beyond merely the spoken words. The recording component 112 may be configured to interpret the speech based on association information used to specify how certain tones, when communicated alone or in combination with other behaviors, may cause a meaning of a message to change beyond mere communication of spoken words. That is, spoken words absent other communicative behaviors may convey a meaning that is simply the meaning of the spoken words and/or sentences formed by the words. However, other behaviors communicated with spoken words may cause the meanings to change. Further, non-verbal communicative behaviors may have meanings on their own. For example, in some implementations a tone may convey a particular word with or without actual words being spoken. For example, a tone changing from a low to high pitch may convey the word “yes” and/or a meaning of affirmation. In some implementations, a tone may covey one or more of feelings, impressions, and/or emotions other than specific words themselves. For example, a tone that starts at a high volume and ends at a low volume convey a feeling of disappointment, frustration, and/or other meanings. Thus, in some implementations, generating the one or more units of work for the users (by work component 114) may based on the meaning of the message conveyed by the speech.

The above examples of are provided for illustrative purposely only and is not to be considered limiting. For example, it is understood that there is a wide range of human utterances and that those utterances, alone or in combination, may convey one or more meanings. The meanings imparted on certain utterances or combinations of utterances may be subjective and/or objective depending on many factors (e.g., culture, age, gender, etc.). Accordingly, the examples are non-exhaustive and are meant as illustrative examples only. Those skilled in the art may appreciate variations and/or alternatives that are within the scope of the present disclosure.

In some implementations, generating the one or more units of work based on the meaning of the message conveyed by the speech may include automatically generating one or more values of one or more work unit parameters of the one or more units of work. The one or more values of the one or more work unit parameters may include values of the work priority parameter and/or other parameters. For example, a first value to the work priority parameter for the first unit of work in comparison to a second value to the work priority parameter for the second unit of work may indicate that the first unit of work of higher priority than the second unit of work. In some implementations, the values to the work priority parameter may part of a range (e.g., 1-10). Based on the values to the work priority parameter, values to other ones the work unit parameters (e.g., due dates, assignees, etc.) may be generated. In some implementations, values of the work priority parameter conveying relatively higher priority may be generate when a message conveyed by speech is determined as having meaning indicating one or more of relative importance, frustration, urgency, and/or other meanings.

In some implementations, the audio content from the audio recording sessions that triggers generation of the one or more units of work for the users may include one or more trigger phrases and/or words. In some implementations, recording component 112 may be configured to detect and/or identify one or more trigger phrases and/or words based on natural language processing and/or other audio processing techniques. The trigger phrases and/or words may indicate a user's request, desire, inquiry, and/or need. By way of non-limiting illustration, the one or more units of work may be generated based on identifying one or more of the trigger phrases and/or words from the audio content. In some implementations, trigger phrases and/or words may include one or more of “to do”, “need to”, “should do”, “check on”, “I need”, “UserA should”, “Did I,” and/or other words and/or phrases. In some implementations, trigger phrases and/or words may be direct recitations of values of one or more work unit parameters of a unit of work to be generated. By way of non-limiting illustration, a user may directly speak a desire to generate a unit of work, with a specific due date, and/or assigned to a specific assignee. By way of non-limiting illustration, a first unit of work may be generated based on identifying a first trigger phrase and/or word from the audio content in the content of the first audio recording session.

In some implementations, work component 114 may be configured to determine context of the audio information. Work component 114 may be configured to generate one or more units of work for the users based on the context of the audio information. The context may include user information for a user participating in the audio recording session, user information for one or more users identified in the audio recording session, and/or other context information. User information for the user may then be obtained. By way of non-limiting illustration, the first audio information may include first context information. The first unit of work may be generated based on the first context information and/or other information.

In some implementations, work component 114 may be configured to identify individual users of the audio recording sessions based on the context of the audio recording sessions, the audio content, and/or other content. In some implementations, the individual users may be identified based on the audio content (e.g., a spoken name, voice detection and/or authentication). In some implementations, speech recognition processing techniques, such as voice authentication, may be used to identify a user of an audio recording session by their voice. In some implementations, individual users may be prompted (through a notification) to explicitly identify the user(s) of the audio recording sessions.

Work component 114 may be configured to obtain individual user records for the individual users. As previously described, individual user records may specify individual sets of preferences of the individual users. Work component 114 may be configured to generate the one or more units of work for the users further based on the individual sets of preferences of the individual users.

In some implementations, work component 114 may identify one or more recommended units of work that should and/or could be generated. The work unit component 114 may be configured to effectuate presentation of one or more recommendation including one or more prompts for generating the one or more recommended units of work. By way of non-limiting example, if a user starts speaking “I need to follow-up with X supplier . . . ”, work component 114 may prompt the user with a recommendation for generating a corresponding unit of work. The prompt may be presented within the user interface in real time and/or near real time during the audio recording session. The user may be able to provide entry and/or selection to accept and/or deny recommendations. By way of non-limiting illustration, work component 114 may generate the unit of work for following-up with X supplier based on the responses to these prompts.

In some implementations, individual units of work may be automatically generated and/or accepted by the users. By way of non-limiting example, the work component 114 may be configured to identify acceptance language based on the audio information for the audio recording sessions. Responsive to the work component 114 identifying acceptance language in response to speech triggering generation of a unit of work, work component 114 may automatically accept one or more generated units of work on behalf of the user. In other implementations, acceptance may be provided through selection of a user interface element (e.g., a virtual button).

Work component 114 may be configured to store the audio information as part of the environment state information. Such storage may be responsive to detection of completion of the audio recording sessions. As such, the audio information may be included in the one or more work unit records generated for the one or more units of work. By way of non-limiting illustration, the first audio information may be stored in the first work unit record. Work component 114 may be configured to communicate with collaboration environment component 110 and/or environment state component 108 to effectuate storage of the information defining the units of work generated as part of the environment state information.

In some implementations, work component 114 may be configured to modify one or more units of work based on the audio content from the audio recording sessions. Modifying one or more units of work may include modifying, changing, adjusting, adding, and/or removing one or more characteristics associated with individual ones of the units of work. By way of non-limiting example, the one or more characteristics of individual ones of the units of work may include one or more of a task description, a user assigned to a task, a due date, a start date, priority, and/or other characteristics of the individual ones of the units of work. A second task may be modified based on the audio content of the first audio information of the first audio recording session. Work component 114 may be configured to store information defining modifications of the units of work as part of the environment state information. As such, information defining a first modification for the second unit of work may be stored in a second work unit record of the second unit of work. In some implementations, modification of units of work may be determined based on one or more trigger phrases and/or words, and/or one or more trigger sounds.

The trigger component 116 may be configured to store trigger information. The trigger information may include trigger sounds, and/or trigger phrases and/or words, and the corresponding values of work unit parameter that may be generated (and/or modified) for one or more units of work. In some implementation, the trigger sounds, and/or trigger phrases and/or words, may be user-specific and/or system-wide. In some implementations, the trigger sounds, and/or trigger phrases and/or words, may be set by users and stored within the user records for the users. In some implementations, the trigger component 116 may be configured to determine trigger sounds, and/or trigger phrases and/or words, through one or more machine learning techniques. By way of non-limiting illustration, a user may go through a training process where an audio recording session and desired units of work are provided as input to train a machine learning model.

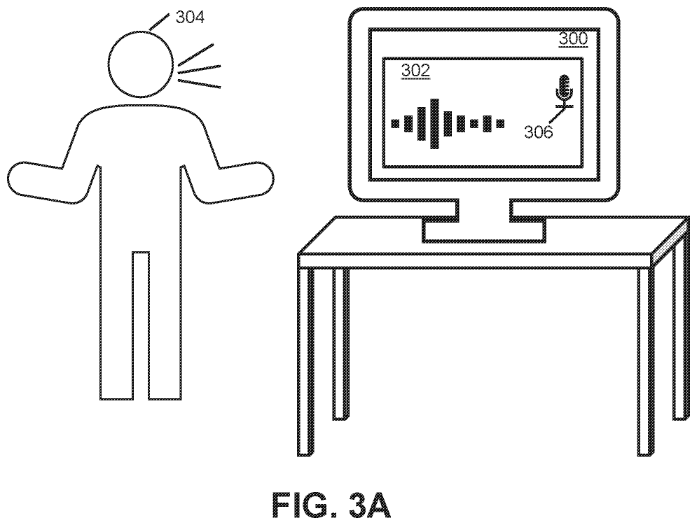

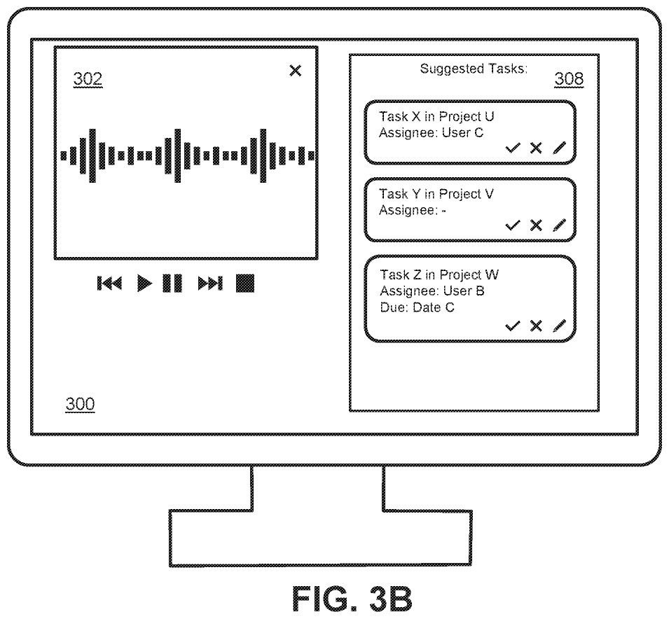

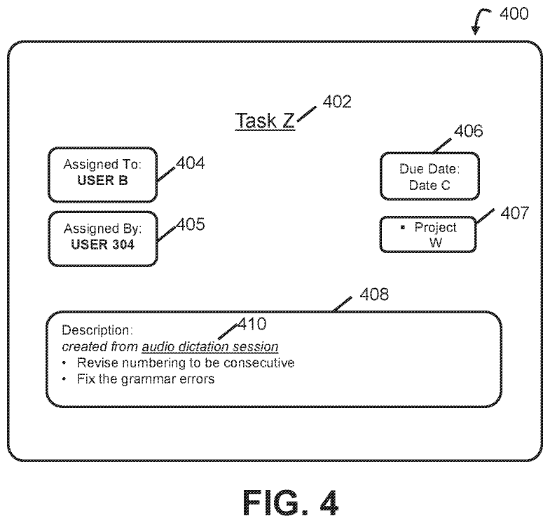

FIG. 3A illustrates an exemplary user interface 302 from which audio information is obtained and used as a basis for generating user units of work, in accordance with one or more implementations. In some implementations, user interface 302 may be presented within a view of collaboration environment 300. User 304 may initiate an audio recording session via user interface 302 by selecting user interface element 306. Audio information defining the audio content of the audio recording session may be used to generate one or more units of work. Speaker intention information may be generated from at least a portion of the audio information. Based on the speaker intention information, frustration regarding corrections to a particular project (e.g., Project W of FIG. 3B and FIG. 4) may be determined. Such concern may trigger generation of a unit of work for the project (e.g., Task Z of FIG. 3B and FIG. 4). User 304 may view an instance of the audio recording session via user interface 302 during the audio recording session.

FIG. 3B illustrates an exemplary audio interface from which audio information is obtained and used as a basis for generating user units of work, in accordance with one or more implementations. Collaboration environment 300 may include audio interface 302 (of which may be played back by one or more users) and suggestion interface 308. The suggestion interface 308 may present one or more recommended units of work. One or more recommended units of work may be automatically generated based on the audio information characterizing the content of the audio recording session and presented in the suggestion interface 308 during the audio recording session. The user may be able to accept and/or reject individual recommended units of work.

FIG. 4 illustrates user interface 400, in accordance with one or more implementations. The user interface 400 may display a first unit of work. The user interface 400 may display different values of one or more work unit parameters of the first unit of work, and/or other information. Individual values of the one or more work unit parameters may be determined based on content of an audio recording session and/or other information. By way of non-limiting illustration, user interface 400 may display one or more user interface elements related to the first unit of work. The one or more user interface elements may include a user interface element 402 that may display a title of the second unit of work (e.g., Task Z). A user interface element 404 may display an assignee of the first unit of work. A user interface element 406 may display a due date of the first unit of work. A user interface element 405 may display an assignor of the first unit of work (e.g., user 304 from audio recording session of FIG. 3A-B). A user interface element 407 may display a project the first unit of work is a part of. A user interface element 408 may display a description for the first unit of work. Some or all of the content of the audio recording session may be displayed in user interface element 408 and/or made accessible via a link 410.

Returning to FIG. 1, in some implementations, server(s) 102, client computing platform(s) 124, and/or external resources 122 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 124, and/or external resources 122 may be operatively linked via some other communication media.

A given client computing platform may include one or more processors configured to execute computer program components. The computer program components may be configured to enable an expert or user associated with the given client computing platform to interface with system 100 and/or external resources 122, and/or provide other functionality attributed herein to client computing platform(s) 124. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 122 may include sources of information outside of system 100, external entities participating with system 100, hosts of audio recording functionality, and/or other resources. In some implementations, some or all of the functionality attributed herein to external resources 124 may be provided by resources included in system 100.

Server(s) 102 may include electronic storage 126, one or more processors 104, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Processor(s) 104 may be configured to provide information processing capabilities in server(s) 102. As such, processor(s) 104 may include one or more of a digital processor, an analog processor, a digital circuit designed to process information, an analog circuit designed to process information, a state machine, and/or other mechanisms for electronically processing information. Although processor(s) 104 is shown in FIG. 1 as a single entity, this is for illustrative purposes only. In some implementations, processor(s) 104 may include a plurality of processing units. These processing units may be physically located within the same device, or processor(s) 104 may represent processing functionality of a plurality of devices operating in coordination. Processor(s) 104 may be configured to execute component 180, and/or other components such as components 110, 112, 114, and/or 116. Processor(s) 104 may be configured to execute components 108, 110, 112, 114, 116, and/or other components by software; hardware; firmware; some combination of software, hardware, and/or firmware; and/or other mechanisms for configuring processing capabilities on processor(s) 104. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although component 108 is illustrated in FIG. 1 as being implemented within a single processing unit, in implementations in which processor(s) 104 includes multiple processing units, component 108 may be implemented remotely from the other components.

Processor(s) 105 may be configured to provide information processing capabilities in client computing platform(s) 124. As such, processor(s) 105 may include one or more of a digital processor, an analog processor, a digital circuit designed to process information, an analog circuit designed to process information, a state machine, and/or other mechanisms for electronically processing information. Although processor(s) 105 is shown in FIG. 1 as a single entity, this is for illustrative purposes only. In some implementations, processor(s) 105 may include a plurality of processing units. These processing units may be physically located within the same device, or processor(s) 105 may represent processing functionality of a plurality of devices operating in coordination. Although components 110, 112, 114, and/or 116 are illustrated in FIG. 1 as being implemented within a single processing unit, in implementations in which processor(s) 105 includes multiple processing units, one or more of components 110, 112, 114, and/or 116 may be implemented remotely from the other components. The description of the functionality provided by the different components 110, 112, 114, and/or 116 described below is for illustrative purposes, and is not intended to be limiting, as any of components 110, 112, 114, and/or 116 may provide more or less functionality than is described. For example, one or more of components 110, 112, 114, and/or 116 may be eliminated, and some or all of its functionality may be provided by other ones of components 110, 112, 114, and/or 116. As another example, processor(s) 104 may be configured to execute one or more additional components that may perform some or all of the functionality attributed below to one of components 110, 112, 114, and/or 116, and/or processor(s) 105 may be configured to execute one or more additional components that may perform some or all of the functionality attributed below to one of components 110, 112, 114, and/or 116.

The electronic storage 126 may include electronic storage media that electronically stores information. The electronic storage media of electronic storage 126 may include one or both of system storage that is provided integrally (i.e., substantially non-removable) with one or more servers 102 and/or removable storage that is removably connected to one or more servers 102. The connection may be facilitated by, for example, a port (e.g., a USB port, a firewire port, etc.) or a drive (e.g., a disk drive, etc.).

The electronic storage 126 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 126 may include one or more virtual storage resources (e.g., cloud storage, a virtual private network, and/or other virtual storage resources). The electronic storage 126 may store software algorithms, information determined by processor(s) 104, information received by one or more servers 102, information received by client computing platforms 124, and/or other information that enables one or more servers 102 to function as described herein.

The electronic storage 126 may be configured to store one or more records and/or information. The one or more records may include one or more of user records 128, project records 130, work unit records 132, and/or other records. The one or more records (e.g., user records 128, project records 130, work unit records 132, and/or other records) may specify and or define values for one or more user parameters, project parameters, work unit parameters, and/or other parameters for the collaboration environment. The one or more records may specify correspondences between one or more of the user records 128, project records 130, work unit records 132, and/or other records. The correspondences may be used to determine which user parameters and/or values, project parameters and/or values, and/or work unit parameters and/or values are associated with a given user, project, and/or unit of work within the collaboration environment.

The electronic storage 120 may include electronic storage media that electronically stores information. The electronic storage media of electronic storage 120 may include one or both of system storage that is provided integrally (i.e., substantially non-removable) with one or more client computing platforms 124 and/or removable storage that is removably connected to one or more client computing platforms 124. The connection may be facilitated by, for example, a port (e.g., a USB port, a firewire port, etc.) or a drive (e.g., a disk drive, etc.).

The electronic storage 120 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 120 may include one or more virtual storage resources (e.g., cloud storage, a virtual private network, and/or other virtual storage resources). The electronic storage 120 may store software algorithms, information determined by processor(s) 105, information received from one or more servers 102, information received by client computing platforms 124, and/or other information that enables one or more client computing platforms 124 to function as described herein.

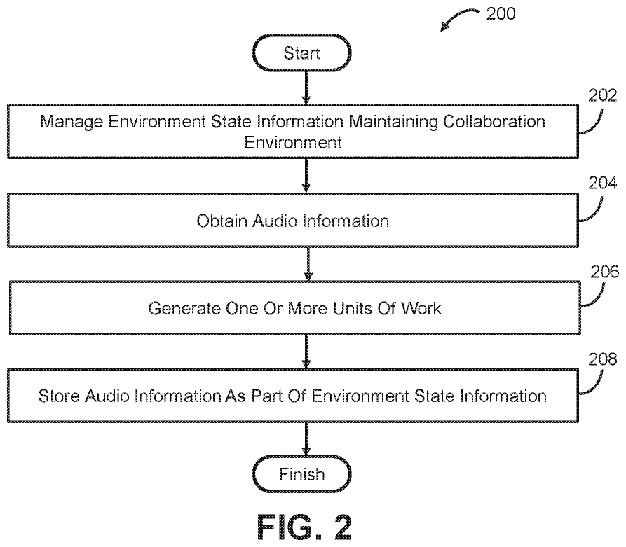

FIG. 2 illustrates a method 200 to generate units of work within a collaboration environment based on audio, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include managing environment state information maintaining a collaboration environment. Operation 202 may be performed by one or more hardware processors configured by machine-readable instructions including a component that is the same as or similar to environment state component 108, in accordance with one or more implementations.

An operation 204 may include obtaining audio information defining audio content from audio recording sessions. The audio content may include speech of individual users during the audio recording sessions. Operation 204 may be performed by one or more hardware processors configured by machine-readable instructions including a component that is the same as or similar to recording component 112, in accordance with one or more implementations.

An operation 206 may include generating one or more units of work for the users based on the audio content of the audio recording sessions. Generating the one or more units of work may be by storing information defining the one or more units of work as part of the environment state information. Operation 206 may be performed by one or more hardware processors configured by machine-readable instructions including a component that is the same as or similar to work component 114, in accordance with one or more implementations.

An operation 208 may include storing the audio information as part of the environment state information. As such, the audio information is included in the one or more work unit records generated for the one or more units of work. Operation 208 may be performed by one or more hardware processors configured by machine-readable instructions including a component that is the same as or similar to work component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to generate units of work within a collaboration environment responsive to user acceptance, via a graphical user interface, of recommended units of work identified based on recorded audio during an audio recording session of the recorded audio, the system comprising:
non-transitory electronic storage storing environment state information maintaining a collaboration environment, the collaboration environment being configured to facilitate interaction by users with the collaboration environment, the environment state information including work unit records describing units of work assigned, created, and/or managed within the collaboration environment; and
one or more physical processors configured by machine-readable instructions to:
manage, by a server, the environment state information maintaining the collaboration environment to facilitate the interaction by the users with the collaboration environment, wherein the users interact with the collaboration environment through remotely located client computing platforms communicating with the server over one or more network connections;
establish the one or more network connections between the server and the remotely located client computing platforms;
effectuate presentation, by the server, of a graphical user interface on the remotely located client computing platforms through which the users initiate and conduct audio recording sessions, the graphical user interface including one or more graphical user interface elements, wherein an individual graphical user interface element is configured to be selected to cause user-initiation of the audio recording sessions;
obtain, by the server, audio recording files including audio content from the audio recording sessions recorded via the remotely located client computing platforms, wherein the audio content includes speech of individual users during the audio recording sessions, including obtaining a first audio recording file including first audio content of a first audio recording session;
execute, by the server, one or more natural language processing operations to identify the audio content from the audio recording files during the audio recording sessions, such that the first audio content is identified based on executing the one or more natural language processing operations with respect to the first audio recording file during the first audio recording session;
identify, by the server and based on the audio content identified through the one or more natural language processing operations, recommended units of work while the users are conducting the audio recording sessions;
responsive to identification of the recommended units of work, effectuate presentation, by the server, of one or more of the recommended units of work within one or more prompts displayed in the graphical user interface while the users are conducting the audio recording sessions, the one or more prompts including one or more graphical user interface elements to be selected to cause user acceptance or denial of the one or more recommended units of work, such that a first recommended unit of work is identified based on the first audio content and presented in a first prompt displayed in the graphical user interface during the first audio recording session;
generate, by the server, one or more work unit records for one or more units of work based on the audio content and whether the users accepted or denied the recommended units of work through user selection in the one or more prompts displayed in the graphical user interface while the users are conducting the audio recording sessions, the one or more work unit records being generated by generating information defining the one or more units of work and storing the information defining the one or more units of work as part of the one or more work unit records, wherein a first work unit record for a first unit of work is generated based on the first audio content and whether the first recommended unit of work was accepted or denied during the first recording session, the first work unit record being generated by generating and storing information defining the first unit of work in the first work unit record; and
effectuate storage, by the server, of the audio recording files in the non-transitory electronic storage as part of the environment state information such that the audio recording files are included in the one or more work unit records generated for the one or more units of work, such that the first audio recording file is stored in the non-transitory electronic storage as part of the first work unit record so that both the information defining the first unit of work and the first audio recording file are made accessible via the first work unit record.

2. The system of claim 1, wherein
the graphical user interface is presented within the collaboration environment.

3. The system of claim 1, wherein the one or more physical processors are further configured by the machine-readable instructions to:
modify one or more of the work unit records based on the audio content, wherein a second work unit record is modified based on the first audio content of the first audio recording file; and
store information defining modifications of the one or more of the work unit records as part of the environment state information such that information defining a first modification of the second work unit record is stored in the second work unit record.

4. The system of claim 1, wherein the audio content that triggers generation of the one or more work unit records includes one or more trigger phrases and/or words, such that the one or more work unit records are generated based on identifying one or more of the trigger phrases and/or words from the audio content, such that the first work unit record is generated based on identifying a first trigger phrase and/or word from the first audio content.

5. The system of claim 1, wherein the one or more physical processors are further configured by the machine-readable instructions to:
generate speaker intention information from the audio recording files, the speaker intention information conveying non-verbalized intent of the users, wherein the non-verbalized intent includes one or more of feelings, impressions, or emotions other than specific words, wherein the non-verbalized intent is determined from tone of the speech, and wherein the tone includes one or more of pitch, vibration, volume, or voice inflection of the speech.

6. The system of claim 5, wherein the one or more physical processors are further configured by the machine-readable instructions to:
interpret the speech of the users based on the speaker intention information to determine a meaning of a message conveyed by the speech; and
wherein generating the one or more work unit records is based on the meaning of the message conveyed by the speech.

7. The system of claim 6, wherein generating the one or more work unit records based on the meaning of the message conveyed by the speech includes automatically generating one or more values of one or more work unit parameters of the one or more work unit records, and the one or more values of the one or more work unit parameters includes values of a work priority parameter determined based on the meaning of the message.

8. The system of claim 1, wherein the one or more physical processors are further configured by the machine-readable instructions to:
identify the individual users of the audio recording sessions based on the audio content;
obtain individual user records for the individual users, wherein the individual user records specify individual sets of preferences of the individual users; and
generate the one or more work unit records further based on the individual sets of preferences of the individual users.

9. The system of claim 8, wherein the individual sets of preferences include individual sets of automated actions to carry out in response to occurrence of individual trigger events.

10. The system of claim 1, wherein the audio recording sessions are live such that the audio recording files are obtained in real time by the server from the remotely located client computing platforms over the one or more network connections as the users utter the speech.

11. A method to generate units of work within a collaboration environment responsive to user acceptance, via a graphical user interface, of recommended units of work identified based on recorded audio during an audio recording session of the recorded audio, the method being implemented in a computer system comprising non-transitory electronic storage and one or more physical processors configured by machine-readable instructions, the method comprising:
storing, by the non-transitory electronic storage, environment state information maintaining a collaboration environment, the collaboration environment being configured to facilitate interaction by users with the collaboration environment, the environment state information including work unit records describing units of work assigned, created, and/or managed within the collaboration environment;
managing, by the server, the environment state information maintaining the collaboration environment to facilitate the interaction by the users with the collaboration environment, wherein the users interact with the collaboration environment through remotely located client computing platforms communicating with the server over one or more network connections;
establishing the one or more network connections between the server and the remotely located client computing platforms;
effectuating presentation, by the server, of a graphical user interface on the remotely located client computing platforms through which the users initiate and conduct audio recording sessions, the graphical user interface including one or more graphical user interface elements, wherein an individual graphical user interface element is configured to be selected to cause user-initiation of the audio recording sessions;
obtaining, by the server, audio recording files including audio content from the audio recording sessions recorded via the remotely located client computing platforms, wherein the audio content includes speech of individual users during the audio recording sessions, including obtaining a first audio recording file including first audio content of a first audio recording session;
executing, by the server, one or more natural language processing operations to identify the audio content from the audio recording files during the audio recording sessions, including executing the one or more natural language processing operations to identify the first audio content of the first audio recording file during the first audio recording session;
identifying, by the server and based on the audio content identified through the one or more natural language processing operations, recommended units of work while the users are conducting the audio recording sessions;
responsive to identification of the recommended units of work, effectuating presentation, by the server, of one or more of the recommended units of work within one or more prompts displayed in the graphical user interface while the users are conducting the audio recording sessions, the one or more prompts including one or more graphical user interface elements to be selected to cause user acceptance or denial of the one or more recommended units of work, such that a first recommended unit of work is identified based on the first audio content and presented in a first prompt displayed in the graphical user interface during the first audio recording session;
generating, by the server, one or more work unit records for one or more units of work based on the audio content and whether the users accepted or denied the recommended units of work through user selection in the one or more prompts displayed in the graphical user interface while the users are conducting the audio recording sessions, the one or more work unit records being generated by generating information defining the one or more units of work and storing the information defining the one or more units of work as part of the one or more work unit records, including generating a first unit of work based on the first audio content and whether the first recommended unit of work was accepted or denied during the first recording session, the first work unit record being generated by generating and storing information defining the first unit of work in a first work unit record; and
effectuating storage, by the server, of the audio recording files in the non-transitory electronic storage as part of the environment state information such that the audio recording files are included in the one or more work unit records generated for the one or more units of work, including effectuating storage of the first audio recording file in the non-transitory electronic storage as part of the first work unit record so that both the information defining the first unit of work and the first audio recording file are made accessible via the first work unit record.

12. The method of claim 11, wherein the graphical user interface is presented within the collaboration environment.

13. The method of claim 11, further comprising:
modifying one or more of the work unit records based on the audio content, wherein a second work unit record is modified based on the first audio content of the first audio recording file; and
storing information defining modifications of the one or more of the work unit records as part of the environment state information such that information defining a first modification of the second work unit record is stored in the second work unit record.

14. The method of claim 11, wherein the audio content that triggers generation of the one or more work unit records includes one or more trigger phrases and/or words, such that the one or more work unit records are generated based on identifying one or more of the trigger phrases and/or words from the audio content, including generating the first work unit record based on identifying a first trigger phrase and/or word from the first audio content.

15. The method of claim 11, further comprising:
generating speaker intention information from the audio recording files, the speaker intention information conveying non-verbalized intent of the users, wherein the non-verbalized intent includes one or more of feelings, impressions, or emotions other than specific words, wherein the non-verbalized intent is determined from tone of the speech, and wherein the tone includes one or more of pitch, vibration, volume, or voice inflection of the speech.

16. The method of claim 15, further comprising:
interpreting the speech of the users based on the speaker intention information to determine a meaning of a message conveyed by the speech; and
wherein the generating the one or more work unit records is based on the meaning of the message conveyed by the speech.

17. The method of claim 16, wherein the generating the one or more work unit records based on the meaning of the message conveyed by the speech includes automatically generating one or more values of one or more work unit parameters of the one or more units of work, and the one or more values of the one or more work unit parameters includes values of a work priority parameter determined based on the meaning of the message.

18. The method of claim 11, further comprising:
identifying the individual users of the audio recording sessions based on the audio content;
obtaining individual user records for the individual users, wherein the individual user records specify individual sets of preferences of the individual users; and
the generating the one or more work unit records is further based on the individual sets of preferences of the individual users.

19. The method of claim 18, wherein the individual sets of preferences include individual sets of automated actions to carry out in response to occurrence of individual trigger events.

20. The method of claim 11, wherein the audio recording sessions are live such that the audio recording files are obtained in real time by the server from the remotely located client computing platforms over the one or more network connections as the users utter the speech.
